(19) United States
(12) Patent Application Publication
(10) Pub. No.: US 2025/0246126 A1
(43) Pub. Date: Jul. 31, 2025

(54) DISPLAY DEVICE

(71) Applicant: Innolux Corporation, Miaoli County (TW)

(72) Inventors: Yi-Shiuan Cherng, Miaoli County (TW); Chia-Hao Tsai, Miaoli County (TW); Yung-Hsun Wu, Miaoli County (TW)

(73) Assignee: Innolux Corporation, Miaoli County (TW)

(21) Appl. No.: 19/002,761

(22) Filed: Dec. 27, 2024

Related U.S. Application Data
(60) Provisional application No. 63/625,283, filed on Jan. 26, 2024.

(30) Foreign Application Priority Data
Oct. 18, 2024 (CN) 202411462394.2

(51) Int. Cl. G09G 3/32; G09G 3/3258

(52) U.S. Cl. CPC G09G 3/32; G09G 3/3258; G09G 2310/08; G09G 2330/021

(57) ABSTRACT

A display device with a low power consumption is provided. The display device includes a pixel circuit. The pixel circuit includes a driving transistor, a light-emitting control transistor, and a light-emitting element. The light-emitting control transistor is electrically connected to a first voltage terminal and the driving transistor. The light-emitting element is electrically connected to a second voltage terminal and the driving transistor. A voltage value of the second voltage terminal is lower than a voltage value of the first voltage terminal. The voltage value of the second voltage terminal in a compensation stage of the pixel circuit is different from the voltage value of the second voltage terminal in a light-emitting stage of the pixel circuit.

### CROSS-REFERENCE TO RELATED APPLICATION

This application claims the priority benefit of U.S. provisional application Ser. No. 63/625,283, filed on Jan. 26, 2024 and China application serial no. 202411462394.2, filed on Oct. 18, 2024. The entirety of each of the above-mentioned patent applications is hereby incorporated by reference herein and made a part of this specification.

### BACKGROUND

### Technical Field

The disclosure relates to a display device, and in particular to a display device with low power consumption.

### Description of Related Art

In a high-brightness environment, the pixel circuit of the display device has operational requirements for high brightness. Therefore, the pixel circuit with a light-emitting diode will operate for a long time by using a high driving current value. This causes the power consumption of the display device to increase.

### SUMMARY

The disclosure provides a display device with a low power consumption.

According to an embodiment of the disclosure, a display device includes a pixel circuit. The pixel circuit includes a driving transistor, a light-emitting control transistor, and a light-emitting element. The light-emitting control transistor is electrically connected to a first voltage terminal and the driving transistor. The light-emitting element is electrically connected to a second voltage terminal and the driving transistor. A voltage value of the second voltage terminal is lower than a voltage value of the first voltage terminal. The voltage value of the second voltage terminal in a compensation stage of the pixel circuit is different from the voltage value of the second voltage terminal in a light-emitting stage of the pixel circuit.

According to an embodiment of the disclosure, a display device includes a pixel circuit. The pixel circuit includes a light-emitting control transistor, a driving transistor, a light-emitting element, and a scan transistor. The driving transistor is electrically connected to a first voltage terminal and the light-emitting control transistor. The light-emitting element is electrically connected to a second voltage terminal and the light-emitting control transistor. A voltage value of the second voltage terminal is less than a voltage value of the first voltage terminal. The scan transistor is electrically connected to the driving transistor and receives a scan signal. A voltage value of the scan signal in a reset stage of the pixel circuit is the same as the voltage value of the scan signal in a scan stage of the pixel circuit.

Based on the above, in the current path between the first voltage terminal and the second voltage terminal, the pixel circuit includes a driving transistor, a light-emitting control transistor, and a light-emitting element. In a conventional pixel circuit that meets high brightness requirements, the current path between the first voltage terminal and the second voltage terminal includes at least three transistors and a light-emitting element. Therefore, compared to a conventional pixel circuit that meets high brightness requirements, the pixel circuit of the disclosure has lower power consumption. In this way, the display device also has lower power consumption.

### BRIEF DESCRIPTION OF THE DRAWINGS

FIG. 1 is a circuit diagram and an operation timing diagram of a pixel circuit of a display device illustrated according to an embodiment of the disclosure.

FIG. 2 is a schematic diagram of an operation timing diagram illustrated according to an embodiment of the disclosure.

FIG. 3 is a schematic diagram of an operation timing diagram illustrated according to an embodiment of the disclosure.

FIG. 4 is a schematic diagram of a pixel circuit of a display device illustrated according to an embodiment of the disclosure.

FIG. 5 is an operation timing diagram illustrated according to an embodiment of the disclosure.

FIG. 6 is an operation timing diagram illustrated according to an embodiment of the disclosure.

FIG. 7 is a diagram of an application scenario of the display device illustrated according to an embodiment of the disclosure.

### DESCRIPTION OF THE EMBODIMENTS

The disclosure may be understood by referring to the following detailed description conducted with reference to the drawings as described below. It should be noted that, for clarity and ease of understanding by the reader, various drawings of the disclosure illustrate a part of an electronic device, and certain elements in each drawing may not be drawn to scale. Additionally, the quantity and size of each device illustrated in the drawings are merely illustrative and are not intended to limit the scope of the disclosure.

Certain terms are used throughout the description and the following claims to refer to specific elements. As those skilled in the art will understand, electronic device manufacturers may use different names to refer to elements. This document does not intend to distinguish elements based on different names rather than different functions. In the following description and in the claims, the terms “comprise”, “include”, and “have” are used in an open-ended manner and should therefore be interpreted as meaning “including but not limited to”. Accordingly, when the terms “comprise”, “include”, and/or “have” are used in the description of the disclosure, they indicate the presence of corresponding features, regions, steps, operations, and/or elements but are not limited to the presence of one or more corresponding features, regions, steps, operations, and/or components.

It should be understood that when an element is referred to as being “coupled to”, “connected to”, or “conducted to” another element, the element may be directly connected to the other element and may directly establish an electrical connection, or there may be an intermediate element between these elements to relay the electrical connection (indirect electrical connection). In contrast, when an element is referred to as being “directly coupled to”, “directly conducted to”, or “directly connected to” another element, there is no intermediate component.

Although terms such as first, second, third, and so on may be used to describe different constituent elements, these constituent elements are not limited by these terms. The terms are only used to distinguish constituent elements in the description from other constituent elements. The claims may not use the same terms but may use terms such as first, second, third, and so on in relation to the order required for the elements. Therefore, in the following description, the first constituent element may be the second constituent element in the claims.

The display device of the disclosure may include a pixel circuit. The pixel circuit may include a light-emitting diode, which may, for example, include an organic light-emitting diode (OLED), a sub-millimeter light-emitting diode (mini LED), a micro light-emitting diode (micro LED), or a quantum dot light-emitting diode (quantum dot LED, which may include QLED, QDLED), or other suitable materials, or combinations of the above, but is not limited thereto. The display device may, for example, include a spliced display device, but is not limited thereto. The antenna device may, for example, be a liquid crystal antenna, but is not limited thereto. The antenna device may, for example, include an antenna splicing device, but is not limited thereto. It should be noted that the electronic device may be any arrangement and combination of the aforementioned, but is not limited thereto. Additionally, the shape of the electronic device may be rectangular, circular, polygonal, with curved edges, or other suitable shapes. The electronic device may include a driving system, a control system, a light source system, and other peripheral systems to support the display device, the antenna device, or the splicing device, but the disclosure is not limited thereto. The sensing device may include a camera, an infrared sensor, a fingerprint sensor, and the disclosure is not limited thereto. In some embodiments, the sensing device may also include a flash, an infrared (IR) light source, other sensors, electronic components, or combinations of the above, but is not limited to this.

In the disclosure, embodiments use “pixel” or “pixel unit” as a unit used to describe a specific area containing at least one functional circuit for at least one specific function. The area of the “pixel” depends on the unit used to provide a specific function. Adjacent pixels may share the same part or wire but may also include their own specific part. For example, adjacent pixels may share the same scan line or the same data line, but the pixel may also have its own transistor or capacitor.

It should be noted that the technical features in the different embodiments described below may be replaced, reorganized, or mixed with each other to form another embodiment without departing from the spirit of the disclosure.

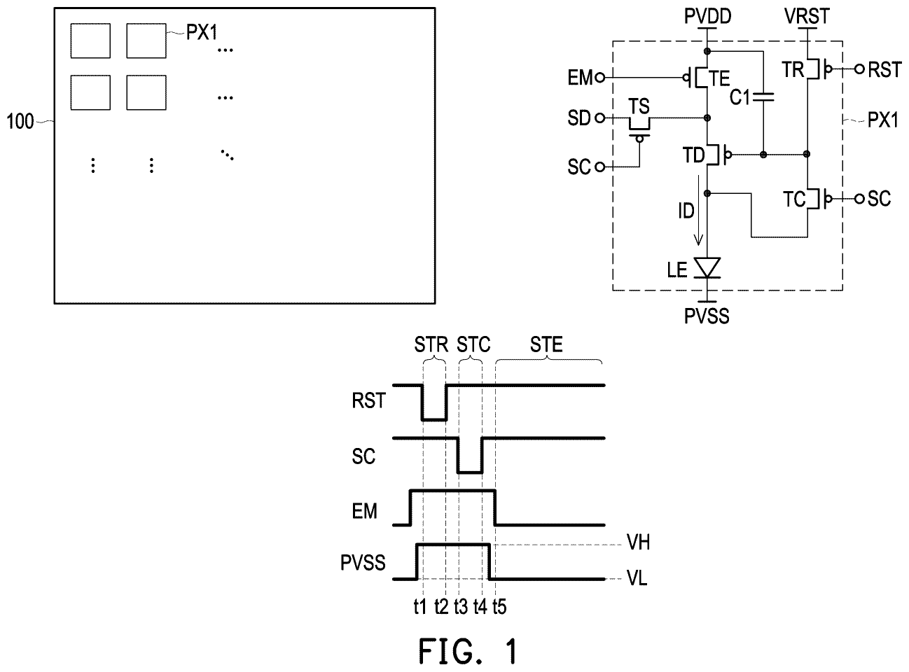

Referring to FIG. 1, FIG. 1 is a circuit diagram and an operation timing diagram of a pixel circuit of a display device illustrated according to an embodiment of the disclosure. In this embodiment, a display device 100 includes a pixel circuit PX1. The pixel circuit PX1 includes a driving transistor TD, a light-emitting control transistor TE, and a light-emitting element LE. The light-emitting control transistor TE is electrically connected to a first voltage terminal PVDD and the driving transistor TD. The light-emitting element LE is electrically connected to a second voltage terminal PVSS and the driving transistor TD. A voltage value of the second voltage terminal PVSS is lower than a voltage value of the first voltage terminal PVDD. That is, the light-emitting control transistor TE, the driving transistor TD, and the light-emitting element LE are connected in series between the first voltage terminal PVDD and the second voltage terminal PVSS.

It is noteworthy here that in the current path between the first voltage terminal PVDD and the second voltage terminal PVSS, the pixel circuit PX1 includes the driving transistor TD, the light-emitting control transistor TE, and the light-emitting element LE. Compared to a conventional pixel circuit meeting high-brightness requirements (for example, a pixel circuit in which the current path between the first voltage terminal PVDD and the second voltage terminal PVSS includes at least three transistors and a light-emitting element), the pixel circuit PX1 has lower power consumption. In this way, the display device 100 also has lower power consumption.

For example, the power consumption P1 of a conventional pixel circuit meeting high-brightness requirements is shown in Formula (1).

$$P 1 = ( V 1 + V 2 + V 3 + VLED ) \times IDD \qquad Formula ( 1 )$$

“V1”, “V2”, and “V3” are expressed as the voltage drops across three transistors in the current path of a conventional pixel circuit. “VLED” is expressed as the voltage drop across the light-emitting element of a conventional pixel circuit. “IDD” is expressed as the current value in the current path of a conventional pixel circuit.

In this embodiment, the power consumption P2 of the pixel circuit PX1 is shown in Formula (2).

$$P 2 = ( VTD + VTE + VLE ) \times IDD \qquad Formula ( 2 )$$

“VTD” is expressed as the voltage drop across the driving transistor TD. “VTE” is expressed as the voltage drop across the light-emitting control transistor TE. “VLED” is expressed as the voltage drop across the light-emitting element of a conventional pixel circuit. “IDD” is expressed as the current value in the current path of a conventional pixel circuit. Therefore, the power consumption P2 of the pixel circuit PX1 may be lower than the power consumption P1 of a conventional pixel circuit.

In this embodiment, the operation of the pixel circuit PX1 may be divided into a reset stage STR, a compensation stage STC, and a light-emitting stage STE. A voltage value VH of the second voltage terminal PVSS in the compensation stage STC of the pixel circuit PX1 is different from a voltage value VL of the second voltage terminal PVSS in the light-emitting stage STE of the pixel circuit PX1. Furthermore, the voltage value VH of the second voltage terminal PVSS in the compensation stage STC is greater than the voltage value VL of the second voltage terminal PVSS in the light-emitting stage STE. Therefore, the light-emitting element LE is in a reverse bias state in the compensation stage STC. In the compensation stage STC, the current value of the driving current ID in the current path between the first voltage terminal PVDD and the second voltage terminal PVSS is approximately equal to “0”. In this way, in the compensation stage STC, the pixel circuit PX1 may avoid the light-emitting element LE being in a forward bias state and mistakenly emitting light.

In this embodiment, a first terminal of the light-emitting control transistor TE is electrically connected to the first voltage terminal PVDD. A control terminal of the light-emitting control transistor TE receives a light-emitting control signal EM. A first terminal of the driving transistor TD is electrically connected to an anode of the light-emitting element LE. A second terminal of the driving transistor TD is electrically connected to a second terminal of the light-emitting control transistor TE. A cathode of the light-emitting element LE is electrically connected to the second voltage terminal PVSS.

In this embodiment, the pixel circuit PX1 further includes a compensation transistor TC, a scan transistor TS, a reset transistor TR, and a capacitor C1. The compensation transistor TC is electrically connected between a control terminal of the driving transistor TD and a first terminal of the driving transistor TD. A first terminal of the compensation transistor TC is electrically connected to the control terminal of the driving transistor TD. A second terminal of the compensation transistor TC is electrically connected to the first terminal of the driving transistor TD. A control terminal of the compensation transistor TC receives a scan signal SC.

A first terminal of the scan transistor TS receives a data signal SD. A second terminal of the scan transistor TS is electrically connected to the second terminal of the driving transistor TD and the second terminal of the light-emitting control transistor TE. A control terminal of the scan transistor TS receives the scan signal SC.

A first terminal of the reset transistor TR receives a reset voltage VRST. A second terminal of the reset transistor TR is electrically connected to the first terminal of the compensation transistor TC and the control terminal of the driving transistor TD. A control terminal of the reset transistor TR receives a reset signal RST.

The capacitor C1 is electrically connected between a first terminal of the light-emitting control transistor TE and a control terminal of the driving transistor TD.

In this embodiment, the driving transistor TD, the light-emitting control transistor TE, the compensation transistor TC, the scan transistor TS, and the reset transistor TR may each be implemented by a P-type transistor; however, the disclosure is not limited thereto.

In this embodiment, in the reset stage STR between time points t1 and t2, the voltage value of the reset signal RST is equal to a low voltage value. The voltage value of the scan signal SC and the voltage value of the light-emitting control signal EM are each equal to a high voltage value. Therefore, the light-emitting control transistor TE, the compensation transistor TC, and the scan transistor TS are turned off. The reset transistor TR is turned on to reset the voltage value at the control terminal of the driving transistor TD using the reset voltage VRST. Therefore, the driving transistor TD is turned on. Additionally, in the reset stage STR, the second voltage terminal PVSS has a voltage value VH. The voltage value VH of the second voltage terminal PVSS in the reset stage STR is different from the voltage value VL of the second voltage terminal PVSS in the light-emitting stage STE. The light-emitting element LE is in a reverse bias state in the reset stage STR.

In the compensation stage STC between time points t3 and t4, the voltage value of the scan signal SC is equal to a low voltage value. The voltage value of the reset signal RST and the voltage value of the light-emitting control signal EM are each equal to a high voltage value. Therefore, the light-emitting control transistor TE and the reset transistor TR are turned off. The scan transistor TS and the compensation transistor TC are turned on. At the beginning of the compensation stage STC, the driving transistor TD is turned on. Therefore, in the compensation stage STC, the voltage value at the control terminal of the driving transistor TD is determined by the voltage value of the data signal SD and the threshold voltage value of the driving transistor TD. The voltage value at the control terminal of the driving transistor TD is approximately equal to the absolute threshold voltage value of the driving transistor TD plus the voltage value of the data signal SD. Therefore, when the driving current ID is generated, the influence of the threshold voltage value of the driving transistor TD on the driving current ID may be reduced.

Additionally, in the compensation stage STC, the second voltage terminal PVSS also has a voltage value VH. That is, the voltage value VH of the second voltage terminal PVSS in the reset stage STR is the same as the voltage value VH of the second voltage terminal PVSS in the compensation stage STC. Therefore, the voltage value VH of the second voltage terminal PVSS in the compensation stage STC is different from the voltage value VL of the second voltage terminal PVSS in the light-emitting stage STE. Additionally, the light-emitting element LE is in a reverse bias state in the compensation stage STC.

In the light-emitting stage STE after a time point t5, the voltage value of the light-emitting control signal EM is equal to a low voltage value. The voltage values of the scan signal SC and the reset signal RST are each equal to a high voltage value. Therefore, the compensation transistor TC, the scan transistor TS, and the reset transistor TR are turned off. The light-emitting control transistor TE is turned on. The second voltage terminal PVSS has a voltage value VL. The light-emitting element LE is in a forward bias state in the light-emitting stage STE. Therefore, when the light-emitting element LE is in a forward bias state and the light-emitting control transistor TE is turned on, the driving current ID is generated based on the voltage value at the control terminal of the driving transistor TD. Therefore, in the light-emitting stage STE, the light-emitting element LE may emit light based on the voltage value at the control terminal of the driving transistor TD.

In some embodiments, the driving transistor TD, the light-emitting control transistor TE, the compensation transistor TC, the scan transistor TS, and the reset transistor TR may each be implemented by an N-type transistor. Therefore, a person skilled in the art may modify the voltage levels of the reset signal RST, the scan signal SC, and the light-emitting control signal EM according to the types of the driving transistor TD, the light-emitting control transistor TE, the compensation transistor TC, the scan transistor TS, and the reset transistor TR.

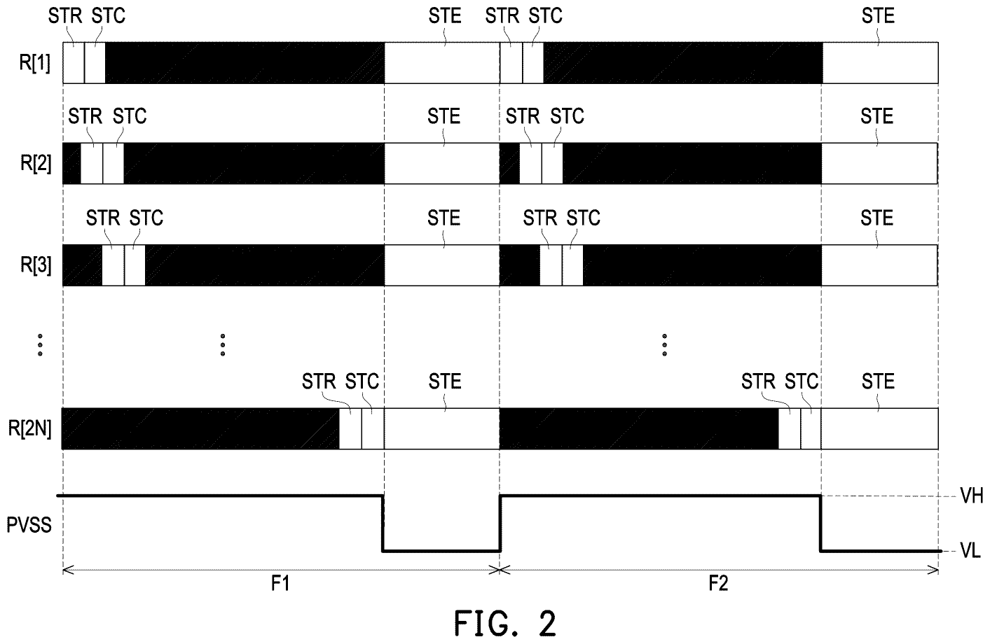

Referring to FIG. 1 and FIG. 2, FIG. 2 is a schematic diagram of an operation timing diagram illustrated according to an embodiment of the disclosure. In this embodiment, multiple pixel circuits PX1 of the display device 100 are grouped as pixel rows R[1]˜R[2N]. The second voltage terminal PVSS is provided to a reference electrode (not shown) of the display device 100. During a frame period F1, the reset stage STR time periods of the pixel rows R[1]˜R[2N] do not overlap with each other. The compensation stage STC time periods of the pixel rows R[1]˜R[2N] do not overlap with each other. For example, the reset stage STR time period of the pixel row R[2] is later than the reset stage STR time period of the pixel row R[1] and at least partially overlaps with the compensation stage STC time period of the pixel row R[1]. The reset stage STR time period of the pixel row R[3] is later than the reset stage STR time period of the pixel row R[2] and at least partially overlaps with the compensation stage STC time period of the pixel row R[2], and so on.

Additionally, during the frame period F1, the light-emitting stage STE time periods of the pixel rows R[1]˜R[2N] may at least partially overlap with each other. The duration of the light-emitting stage STE for the pixel rows R[1]˜R[2N] is the same as each other, but this is not limiting. The second voltage terminal PVSS has a voltage value VL in the light-emitting stage STE. During the reset and compensation periods outside of the light-emitting stage STE, the second voltage terminal PVSS has a voltage value VH. The operation timing of a frame period F2 is similar to the operation timing of the frame period F1.

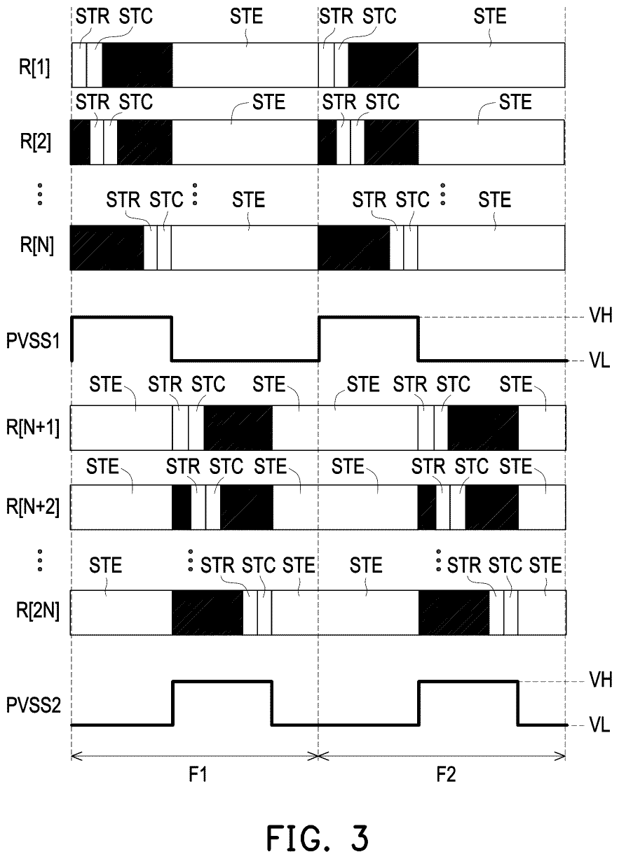

Referring to FIG. 1 and FIG. 3, FIG. 3 is a schematic diagram of an operation timing diagram illustrated according to an embodiment of the disclosure. In this embodiment, multiple pixel circuits PX1 of the display device 100 are grouped as pixel rows R[1]˜R[2N]. A second voltage terminal PVSS1 is provided to a first reference electrode (not shown) of the display device 100. A second voltage terminal PVSS2 is provided to a second reference electrode (not shown) of the display device 100. In this embodiment, the first reference electrode corresponds to the pixel rows R[1]˜R[N]. The second reference electrode corresponds to the pixel rows R[N+1]˜R[2N].

The reset stage STR time periods of the pixel rows R[1]˜R[N] do not overlap with each other. The compensation stage STC time periods of the pixel rows R[1]˜R[N] do not overlap with each other. For example, the reset stage STR time period of the pixel row R[2] is later than the reset stage STR time period of the pixel row R[1] and at least partially overlaps with the compensation stage STC time period of the pixel row R[1]. The light-emitting stage STE time periods of the pixel rows R[1]˜R[N] may at least partially overlap with each other. The second voltage terminal PVSS1 has a voltage value VL in the light-emitting stage STE of the pixel rows R[1]˜R[N]. During the reset and compensation periods outside of the light-emitting stage STE of the pixel rows R[1]˜R[N], the second voltage terminal PVSS1 has a voltage value VH.

The reset stage STR time periods of the pixel rows R[N+1]˜R[2N] do not overlap with each other. The compensation stage STC time periods of the pixel rows R[N+1]˜R[2N] do not overlap with each other. For example, the reset stage STR time period of the pixel row R[N+2] is later than the reset stage STR time period of the pixel row R[N+1] and at least partially overlaps with the compensation stage STC time period of the pixel row R[N+1]. The light-emitting stage STE time periods of the pixel rows R[N+1]˜R[2N] may at least partially overlap with each other. The second voltage terminal PVSS2 has a voltage value VL in the light-emitting stage STE of the pixel rows R[N+1]˜R[2N]. During the reset and compensation periods outside of the light-emitting stage STE of the pixel rows R[N+1]˜R[2N], the second voltage terminal PVSS1 has a voltage value VH. It should be noted that the duration of the light-emitting stage STE for the pixel rows R[1]˜R[2N] is the same as each other. The second voltage terminal PVSS1 is provided to a first reference electrode of the display device 100. The second voltage terminal PVSS2 is provided to a second reference electrode of the display device 100. The second voltage terminal PVSS1 corresponding to the pixel rows R[1]˜R[N] and the second voltage terminal PVSS2 corresponding to the pixel rows R[N+1]˜R[2N] may be individually controlled. Therefore, the starting time point of the light-emitting stage STE of the pixel rows R[1]˜R[N] and the starting time point of the light-emitting stage STE of the pixel rows R[N+1]˜R[2N] may differ from each other. In this embodiment, the reset and compensation periods of the frame periods F1 and F2 may be shortened, and the light-emitting stage STE of the multiple pixel circuits PX1 of the display device 100 may be extended. For example, the length of the light-emitting stage STE in FIG. 3 is approximately twice the duration of the light-emitting stage STE in FIG. 2. In the disclosure, the number of reference electrodes of the display device 100 is not limited and may, for example, be one, two, or more than two. In this embodiment, the operation of the frame period F2 is similar to the operation of the frame period F1.

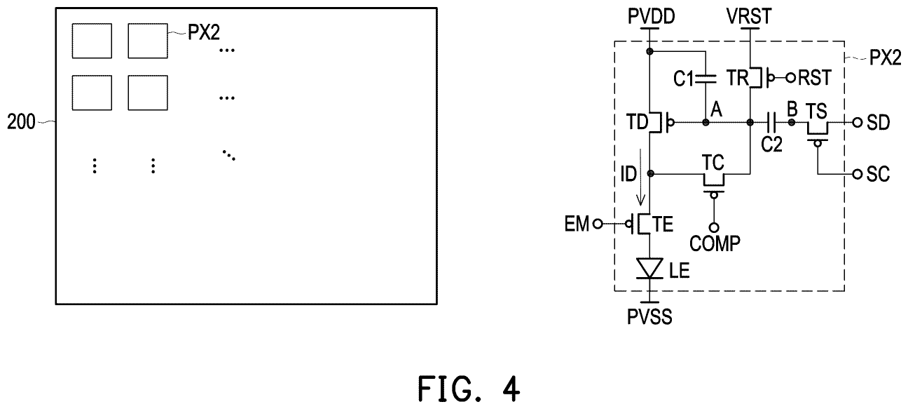

Referring to FIG. 4, FIG. 4 is a schematic diagram of a pixel circuit of a display device illustrated according to an embodiment of the disclosure. In this embodiment, a display device 200 includes a pixel circuit PX2. The pixel circuit PX2 includes a light-emitting control transistor TE, a driving transistor TD, a light-emitting element LE, and a scan transistor TS. The driving transistor TD is electrically connected to a first voltage terminal PVDD and the light-emitting control transistor TE. The light-emitting element LE is electrically connected to a second voltage terminal PVSS and the light-emitting control transistor TE. The voltage value of the second voltage terminal PVSS is lower than the voltage value of the first voltage terminal PVDD. That is, the driving transistor TD, the light-emitting control transistor TE, and the light-emitting element LE are connected in series between the first voltage terminal PVDD and the second voltage terminal PVSS. Additionally, the scan transistor TS is electrically connected to the driving transistor TD and receives a scan signal SC.

It is noteworthy here that in the current path between the first voltage terminal PVDD and the second voltage terminal PVSS, the pixel circuit PX2 includes the driving transistor TD, the light-emitting control transistor TE, and the light-emitting element LE. In a conventional pixel circuit that meets high-brightness requirements, the current path between the first voltage terminal PVDD and the second voltage terminal PVSS includes at least three transistors and a light-emitting element. Therefore, compared to a conventional pixel circuit that meets high-brightness requirements, the pixel circuit PX2 has lower power consumption. In this way, the display device 200 also has lower power consumption.

In this embodiment, a first terminal of the driving transistor TD is electrically connected to a first terminal of the light-emitting control transistor TE. A second terminal of the driving transistor TD is electrically connected to the first voltage terminal PVDD. A second terminal of the light-emitting control transistor TE is electrically connected to an anode of the light-emitting element LE. A control terminal of the light-emitting control transistor TE receives a light-emitting control signal EM. A cathode of the light-emitting element LE is electrically connected to the second voltage terminal PVSS.

In this embodiment, the pixel circuit PX2 further includes a compensation transistor TC, a reset transistor TR, and capacitors C1 and C2. The compensation transistor TC is electrically connected between a control terminal of the driving transistor TD and a first terminal of the driving transistor TD. A first terminal of the compensation transistor TC is electrically connected to the control terminal of the driving transistor TD. A second terminal of the compensation transistor TC is electrically connected to the first terminal of the driving transistor TD. A control terminal of the compensation transistor TC receives a compensation signal COMP.

A first terminal of the reset transistor TR receives a reset voltage VRST. A second terminal of the reset transistor TR is electrically connected to the first terminal of the compensation transistor TC and the control terminal of the driving transistor TD. A control terminal of the reset transistor TR receives a reset signal RST.

The capacitor C1 is electrically connected between a second terminal of the driving transistor TD and the control terminal of the driving transistor TD.

A first terminal of the scan transistor TS receives a data signal SD. A control terminal of the scan transistor TS receives a scan signal SC. A capacitor C2 is electrically connected between the control terminal of the driving transistor TD and a second terminal of the scan transistor TS.

In this embodiment, the driving transistor TD, the light-emitting control transistor TE, the compensation transistor TC, the scan transistor TS, and the reset transistor TR may each be implemented by a P-type transistor; however, the disclosure is not limited thereto.

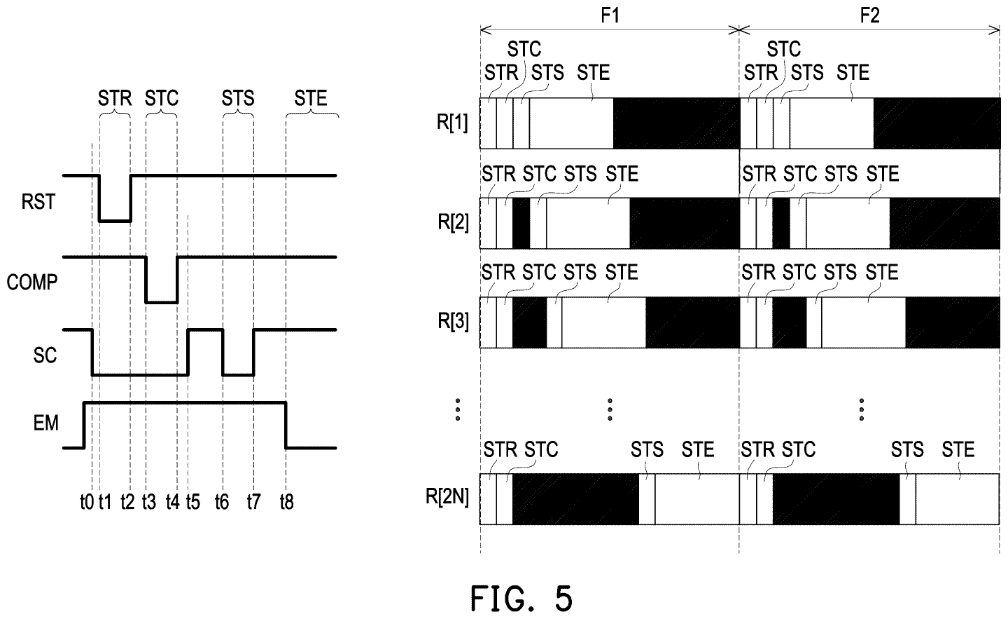

Referring to FIG. 4 and FIG. 5, FIG. 5 is an operation timing diagram illustrated according to an embodiment of the disclosure. In this embodiment, the operation of the pixel circuit PX2 may be divided into a reset stage STR, a compensation stage STC, a scan stage STS, and a light-emitting stage STE.

In this embodiment, during the period from the time point t0 to the time point t5, the voltage value of the scan signal SC is equal to a low voltage value.

In the reset stage STR between the time points t1 and t2, the voltage value of the reset signal RST is equal to a low voltage value. The voltage value of the compensation signal COMP and the voltage value of the light-emitting control signal EM are each equal to a high voltage value. Therefore, the light-emitting control transistor TE and the compensation transistor TC are turned off. The scan transistor TS and the reset transistor TR are turned on. The reset transistor TR resets the voltage at a second terminal (i.e., a node A) of the reset transistor TR using the reset voltage VRST. The scan transistor TS stabilizes the voltage at a second terminal (i.e., a node B) of the scan transistor TS using the data signal SD.

In the compensation stage STC between the time points t3 and t4, the voltage value of the compensation signal COMP is equal to a low voltage value. The voltage values of the reset signal RST and the light-emitting control signal EM are each equal to a high voltage value.

Therefore, the light-emitting control transistor TE and the reset transistor TR are turned off. The scan transistor TS and the compensation transistor TC are turned on. At the beginning of the compensation stage STC, the driving transistor TD is turned on. Therefore, in the compensation stage STC, the voltage value at the control terminal of the driving transistor TD retains a threshold voltage value (e.g., Vth) of the driving transistor TD.

It should be noted that in the compensation stage STC, the pixel circuit PX2 may stabilize the voltage level at the node A by using the capacitive coupling of the capacitors C1 and C2.

During the period from the time point t5 to a time point t6, the voltage value of the scan signal SC is equal to a high voltage value.

In the scan stage STS between time points t6 and t7, the voltage value of the scan signal SC is equal to a low voltage value. That is, the voltage value of the scan signal SC in the reset stage STR is the same as the voltage value of the scan signal SC in the scan stage STS. Additionally, the voltage value of the scan signal SC in the compensation stage STC is also the same as the voltage value of the scan signal SC in the scan stage STS.

In the scan stage STS, the voltage values of the reset signal RST, the compensation signal COMP, and the light-emitting control signal EM are each equal to a high voltage value. The control terminal (i.e., the node A) of the driving transistor TD is floating. The scan transistor TS is turned on. Therefore, in the scan stage STS, the pixel circuit PX2 may couple the voltage value of the data signal SD to the control terminal of the driving transistor TD using the capacitor C2.

In the light-emitting stage STE after a time point t8, the voltage value of the light-emitting control signal EM is equal to a low voltage value. The voltage value of the scan signal SC in the light-emitting stage STE is different from the voltage value of the scan signal SC in the scan stage STS. In the light-emitting stage STE, the voltage value of the scan signal SC is equal to a high voltage value. That is, the voltage value of the scan signal SC in the light-emitting stage STE is greater than the voltage value of the scan signal SC in the scan stage STS.

In the light-emitting stage STE, the voltage values of the compensation signal COMP and the reset signal RST are each equal to a high voltage value. Therefore, the compensation transistor TC, the scan transistor TS, and the reset transistor TR are turned off. The light-emitting control transistor TE is turned on. The driving current ID is generated based on the voltage value at the control terminal of the driving transistor TD. Therefore, in the light-emitting stage STE, the light-emitting element LE may emit light based on the voltage value at the control terminal of the driving transistor TD.

In this embodiment, multiple pixel circuits PX2 of the display device 200 are grouped as pixel rows R[1]˜R[2N]. During the frame period F1, the reset stage STR time periods of the pixel rows R[1]˜R[2N] at least partially overlap. The compensation stage STC time periods of the pixel rows R[1]˜R[2N] at least partially overlap. The scan stage STS time periods of the pixel rows R[1]˜R[2N] do not overlap with each other. Therefore, the length of the time period between the time points t5 and t6 varies according to the different pixel rows R[1]˜R[2N]. The light-emitting stage STE follows the scan stage STS. Therefore, the starting time points of the light-emitting stage STE of the pixel rows R[1]˜R[2N] are different from each other. The operation timing of the frame period F2 is similar to the operation timing of the frame period F1. The duration of the light-emitting stage STE of the pixel rows R[1]˜R[2N] is the same as each other, but this is not limiting.

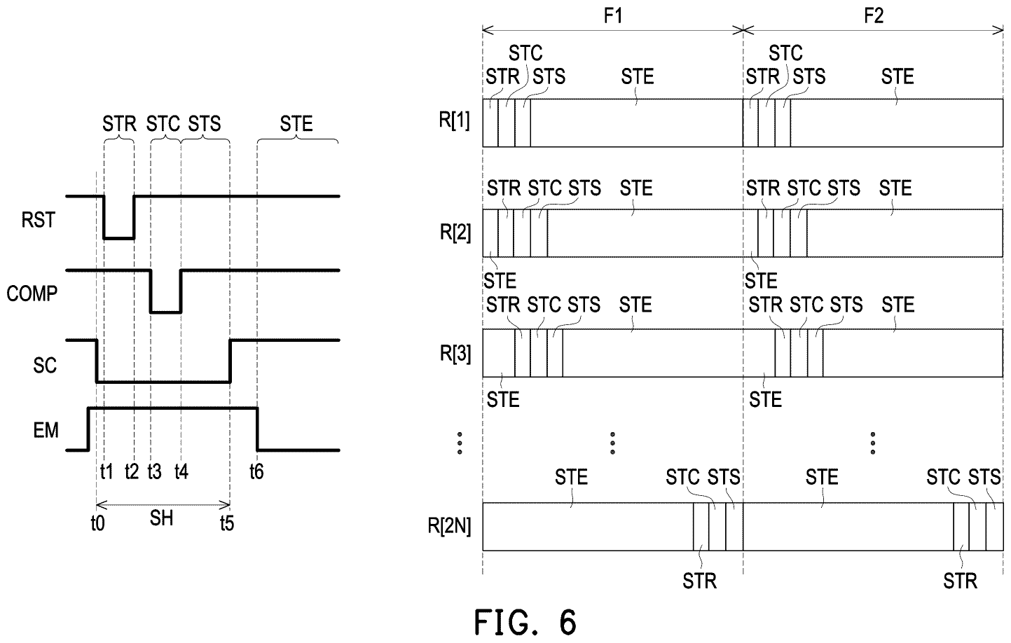

Referring to FIG. 4 and FIG. 6, FIG. 6 is an operation timing diagram illustrated according to an embodiment of the disclosure. In this embodiment, the operation of the pixel circuit PX2 may be divided into a reset stage STR, a compensation stage STC, a scan stage STS, and a light-emitting stage STE.

In this embodiment, during an update stage SH between the time points to and t5, the voltage value of the scan signal SC is equal to a low voltage value.

In the reset stage STR between the time points t1 and t2, the voltage value of the reset signal RST is equal to a low voltage value. The voltage values of the compensation signal COMP and the light-emitting control signal EM are each equal to a high voltage value. Therefore, the light-emitting control transistor TE and the compensation transistor TC are turned off. The scan transistor TS and the reset transistor TR are turned on. The reset transistor TR resets the voltage at the second terminal (i.e., the node A) of the reset transistor TR using the reset voltage VRST. The scan transistor TS stabilizes the voltage at the second terminal (i.e., the node B) of the scan transistor TS using the data signal SD.

In the compensation stage STC between the time points t3 and t4, the voltage value of the compensation signal COMP is equal to a low voltage value. The voltage values of the reset signal RST and the light-emitting control signal EM are each equal to a high voltage value. Therefore, the light-emitting control transistor TE and the reset transistor TR are turned off. The scan transistor TS and the compensation transistor TC are turned on. At the beginning of the compensation stage STC, the driving transistor TD is turned on. Therefore, in the compensation stage STC, the voltage value at the control terminal of the driving transistor TD retains the threshold voltage value (e.g., Vth) of the driving transistor TD.

It should be noted that in the compensation stage STC, the pixel circuit PX2 may stabilize the voltage level at the node A by using the capacitive coupling of the capacitors C1 and C2.

In the scan stage STS between the time points t4 and t5, the voltage values of the reset signal RST, the compensation signal COMP, and the light-emitting control signal EM are each equal to a high voltage value. The control terminal (i.e., the node A) of the driving transistor TD is floating. The scan transistor TS is turned on. Therefore, in the scan stage STS, the pixel circuit PX2 may couple the voltage value of the data signal SD to the control terminal of the driving transistor TD using the capacitor C2.

In the light-emitting stage STE after the time point t6, the voltage value of the light-emitting control signal EM is equal to a low voltage value. The voltage value of the scan signal SC in the light-emitting stage STE is different from the voltage value of the scan signal SC in the scan stage STS. In the light-emitting stage STE, the voltage value of the scan signal SC is equal to a high voltage value. That is, the voltage value of the scan signal SC in the light-emitting stage STE is greater than the voltage value of the scan signal SC in the scan stage STS.

In the light-emitting stage STE, the voltage values of the compensation signal COMP and the reset signal RST are each equal to a high voltage value. Therefore, the compensation transistor TC, the scan transistor TS, and the reset transistor TR are turned off. The light-emitting control transistor TE is turned on. The driving current ID is generated based on the voltage value at the control terminal of the driving transistor TD. Therefore, in the light-emitting stage STE, the light-emitting element LE may emit light based on the voltage value at the control terminal of the driving transistor TD.

It should be noted that the reset stage STR, the compensation stage STC, and the scan stage STS are conducted during the update stage SH.

In this embodiment, multiple pixel circuits PX2 of the display device 200 are grouped as pixel rows R[1]˜R[2N]. During the frame period F1, the update stage SH time periods of two adjacent pixel rows R[1]˜R[2N] may partially overlap. For example, the reset stage STR time periods of the pixel rows R[1]˜R[2N] do not overlap with each other. The compensation stage STC time periods of the pixel rows R[1]˜R[2N] do not overlap with each other. The scan stage STS time periods of the pixel rows R[1]˜R[2N] do not overlap with each other. For example, the reset stage STR time period of the pixel row R[2] is later than the reset stage STR time period of the pixel row R[1] and at least partially overlaps with the compensation stage STC time period of the pixel row R[1]. The compensation stage STC time period of the pixel row R[2] is later than the compensation stage STC time period of the pixel row R[1] and at least partially overlaps with the scan stage STS time period of the pixel row R[1].

Additionally, the time period outside of the update stage SH may be the light-emitting stage STE. The light-emitting stage STE of the multiple pixel circuits PX2 of the display device 100 may be extended.

In this embodiment, the operation of the frame period F2 is similar to the operation of the frame period F1.

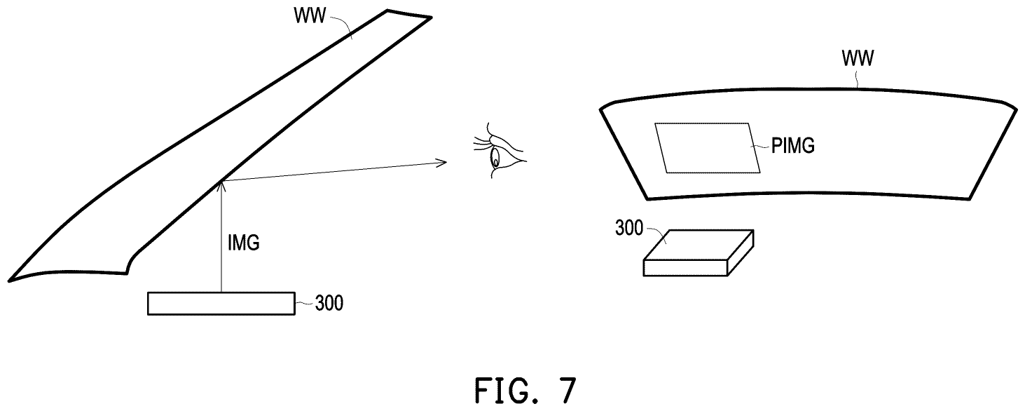

Referring to FIG. 7, FIG. 7 is an application scenario diagram of a display device illustrated according to an embodiment of the disclosure. In this embodiment, a display device 300 may include the pixel circuit PX1 as shown in FIG. 1 or the pixel circuit PX2 as shown in FIG. 4. Therefore, the display device 300 may meet high PPI (pixels per inch) and/or high brightness requirements. In this embodiment, the display device 300 may, for example, be suitable for a head-up display (HUD) of a vehicle, such as an aircraft or car.

In this embodiment, the display device 300 may project an image IMG onto a windshield WW to produce a projected image PIMG. Since the display device 300 may meet the display requirements of high PPI and/or high brightness, the projected image PIMG remains clear under high ambient brightness based on the visual perception of the user. Additionally, compared to conventional pixel circuits, both the pixel circuit PX1 as shown in FIG. 1 and the pixel circuit PX2 as shown in FIG. 4 have lower power consumption. Therefore, in this embodiment, the power consumption of the display device 300 is also lower.

In summary, in the current path between the first voltage terminal and the second voltage terminal, the pixel circuit includes a driving transistor, a light-emitting control transistor, and a light-emitting element. Compared to conventional pixel circuits that meet high-brightness requirements (for example, in which the current path between the first voltage terminal and the second voltage terminal includes at least three transistors and a light-emitting element), the pixel circuit of the disclosure has lower power consumption. In this way, the display device of the disclosure also has lower power consumption.

Finally, it should be stated that the above embodiments are provided solely to illustrate the technical solutions of the disclosure and not to limit them. Although the disclosure has been described in detail with reference to the above embodiments, those skilled in the art should understand that they may still modify the technical solutions described in the above embodiments or make equivalent replacements for some or all of the technical features therein. Such modifications or replacements do not cause the essence of the corresponding technical solutions to depart from the scope of the technical solutions of the various embodiments of the disclosure.

What is claimed is:

1. A display device, comprising:
a pixel circuit, comprising:
a driving transistor;
a light-emitting control transistor, electrically connected to a first voltage terminal and the driving transistor; and
a light-emitting element, electrically connected to a second voltage terminal and the driving transistor, wherein a voltage value of the second voltage terminal is lower than a voltage value of the first voltage terminal,
wherein the voltage value of the second voltage terminal in a compensation stage of the pixel circuit is different from the voltage value of the second voltage terminal in a light-emitting stage of the pixel circuit.

2. The display device according to claim 1, wherein the voltage value of the second voltage terminal in the compensation stage is greater than the voltage value of the second voltage terminal in the light-emitting stage.

3. The display device according to claim 1, wherein the voltage value of the second voltage terminal in a reset stage of the pixel circuit is different from the voltage value of the second voltage terminal in the light-emitting stage.

4. The display device according to claim 3, wherein the voltage value of the second voltage terminal in the reset stage is a same as the voltage value of the second voltage terminal in the compensation stage.

5. The display device according to claim 1, wherein the pixel circuit further comprises:
a compensation transistor, electrically connected between a control terminal of the driving transistor and a first terminal of the driving transistor.

6. The display device according to claim 5, wherein:
a first terminal of the light-emitting control transistor is electrically connected to the first voltage terminal,
a second terminal of the light-emitting control transistor is electrically connected to a second terminal of the driving transistor, and
a control terminal of the light-emitting control transistor receives a light-emitting control signal.

7. The display device according to claim 5, wherein the pixel circuit further comprises:
a scan transistor, wherein a first terminal of the scan transistor receives a data signal, a second terminal of the scan transistor is electrically connected to a second terminal of the driving transistor, and a control terminal of the scan transistor receives a scan signal.

8. The display device according to claim 5, wherein the first terminal of the driving transistor is electrically connected to the light-emitting element.

9. The display device according to claim 1, wherein the pixel circuit further comprises:
a capacitor, electrically connected between a control terminal of the driving transistor and a first terminal of the light-emitting control transistor.

10. The display device according to claim 1, wherein the pixel circuit further comprises:
a reset transistor, wherein a first terminal of the reset transistor receives a reset voltage, a second terminal of the reset transistor is electrically connected to a control terminal of the driving transistor, and a control terminal of the reset transistor receives a reset signal.

11. A display device, comprising:
a pixel circuit, comprising:
a light-emitting control transistor;
a driving transistor, electrically connected to a first voltage terminal and the light-emitting control transistor;
a light-emitting element, electrically connected to a second voltage terminal and the light-emitting control transistor, wherein a voltage value of the second voltage terminal is less than a voltage value of the first voltage terminal; and
a scan transistor, electrically connected to the driving transistor and receiving a scan signal,
wherein a voltage value of the scan signal in a reset stage of the pixel circuit is a same as the voltage value of the scan signal in a scan stage of the pixel circuit.

12. The display device according to claim 11, wherein the voltage value of the scan signal in a light-emitting stage of the pixel circuit is different from the voltage value of the scan signal in the scan stage.

13. The display device according to claim 12, wherein the voltage value of the scan signal in the light-emitting stage is greater than the voltage value of the scan signal in the scan stage.

14. The display device according to claim 11, wherein the voltage value of the scan signal in a compensation stage of the pixel circuit is the same as the voltage value of the scan signal in the scan stage.

15. The display device according to claim 11, wherein the pixel circuit further comprises:
a compensation transistor, electrically connected between a control terminal of the driving transistor and a first terminal of the driving transistor.

16. The display device according to claim 15, wherein:
the first terminal of the driving transistor is electrically connected to a first terminal of the light-emitting control transistor, and
a second terminal of the driving transistor is electrically connected to the first voltage terminal.

17. The display device according to claim 16, wherein:
a second terminal of the light-emitting control transistor is electrically connected to the light-emitting element, and
a control terminal of the light-emitting control transistor receives a light-emitting control signal.

18. The display device according to claim 16, wherein the pixel circuit further comprises:
a reset transistor, wherein a first terminal of the reset transistor receives a reset voltage, a second terminal of the reset transistor is electrically connected to the control terminal of the driving transistor, and a control terminal of the reset transistor receives a reset signal.

19. The display device according to claim 16, wherein the pixel circuit further comprises:
a first capacitor, electrically connected between the second terminal of the driving transistor and the control terminal of the driving transistor.

20. The display device according to claim 11, wherein the pixel circuit further comprises:
a second capacitor, electrically connected between a control terminal of the driving transistor and the scan transistor.
